(19) United States
(12) Patent Application Publication
(10) Pub. No.: US 2013/0223404 A1
(43) Pub. Date: Aug. 29, 2013

(54) CARE-OF-ADDRESS HANDOVER

(71) Applicant: Martin KOLDE, Munich (DE)

(72) Inventor: Martin KOLDE, Munich (DE)

(21) Appl. No.: 13/758,240

(22) Filed: Feb. 4, 2013

Related U.S. Application Data
(60) Provisional application No. 61/602,801, filed on Feb. 24, 2012.

(51) Int. Cl. H04W 36/00

(52) U.S. Cl. CPC H04W 36/00
USPC 370/331

(57) ABSTRACT

Representative implementations of devices and techniques provide care-of-address handover. In one implementation, a message is sent to a server in a point-to-point communication session. The message includes a care-of-address of a first network interface (e.g., wireless network interface) and a care-of-address of a second network interface (e.g., wireline network interface). The care-of-address of the first network interface is a current care-of-address being used in the communication session and the care-of-address of the second network interface is a new care-of-address that a device (e.g., a mobile node) is going to transition to (e.g., handover). The message may also include the server's IP address and TCP (Transfer Control Protocol) port. Furthermore, the message may include the mobile node's TCP port.

### RELATED APPLICATION

This application priority benefit of Provisional Application 61/602,801, filed on Feb. 24, 2012. The entire contents of the Provisional application are incorporated herein by reference.

### BACKGROUND

Today's mobile computing environment requires the ability to seamlessly route communication content associated with nodes that routinely connect to a data network at different points of attachment, e.g., via air and wireline interfaces. Such nodes include cellular telephones, Personal Digital Assistants (PDAs), laptop computers, and other mobile wireless communication equipment.

In one example, a mobile node may wirelessly and continuously be connected to a network infrastructure using the same Internet Protocol (IP) address regardless of the mobile node's physical location. The mobile node may be identified by a home address associated with the mobile node's home network. When the mobile node connects to the network infrastructure, the mobile node is identified by the home address and by at least one care-of-address.

Information sent across the network infrastructure to the mobile node's home address is transparently routed to the mobile node's care-of-address. The information destined for the mobile node's home address is received at the home link by a home gateway or router that tunnels the information to the mobile node's care-of address via an IP tunnel.

As the mobile node changes its physical location or connects to a different network interface (e.g., wireline or wireless) and switches to a different foreign gateway or router to maintain connectivity to the network infrastructure, the mobile node updates the home gateway or router with its new care-of address. In this way, the mobile node can relocate, connect to various foreign gateways or routers, and maintain a constant IP address presence without interruptions or disturbances in network connectivity.

However, when the mobile node switches between two different network interfaces while an IP application is running, the IP connection is interrupted at the moment the mobile node leaves the old network link. This connection is interrupted at least until at the mobile node the new link to the network has been made and until the new location, i.e. the new care-of-address, is known and has been updated in the home gateway. If the interruption time for the change exceeds the time-out delays specified e.g. in the TCP (Transfer Control Protocol) for dead times, the IP connection is interrupted. Even when the interruption time lies within the time-out delays specified in the TCP, however, the IP applications are not able to maintain the connection if a network interface is not permanently available and uninterrupted. This leads to the IP applications having to be restarted normally when a mobile node switches between two different network interfaces in order to be able to access a particular IP data tunnel.

Another problem is that, on the side of the mobile node, the data packets get lost in downtime between the connections since no physical network device is assigned anymore. This is particularly problematic in point-to-point connections, such a VoIP, that require uninterrupted data transfer.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a graphical representation of a communication system that may implement, at least in part, the disclosed care-of-address handover techniques and processes.

FIG. 2 is a schematic of an example communication block, according to an implementation.

FIG. 3 illustrates a representative process to initiate a change in a care-of address associated with computing device, such as the requester 135.

FIG. 4 illustrates an example computing device within which the described systems and methods can be either fully or partially implemented.

### DETAILED DESCRIPTION

### Overview

Representative implementations of devices and techniques provide care-of address handover. In one implementation, a message is sent to a server in a point-to-point communication session. The message includes a care-of-address of a first network interface (e.g., wireless network interface) and a care-of-address of a second network interface (e.g., wireline network interface). The care-of-address of the first network interface is a current care-of-address being used in the communication session and the care-of-address of the second network interface is a new care-of-address that a device (e.g., a mobile node) is going to transition to (e.g., handover). The message may also include the server's IP address and TCP (Transfer Control Protocol) port. Furthermore, the message may include the mobile node's TCP port.

In one implementation, the server establishes a NAT (Network Address Translation)/proxy that properly routes data communicated from the server to the mobile node. In one implementation, the server continues to address and send data to the care-of-address of the first network interface (i.e., the old care-of-address). The NAT/Proxy modifies data that passes there-through to include the new care-of-address of the second network interface.

Various implementations, including techniques and devices, are discussed with reference to the figures. The techniques and devices discussed may be applied to any of various network designs, circuits, and devices and remain within the scope of the disclosure.

Implementations are explained in more detail below using a plurality of examples. Although various implementations and examples are discussed here and below, further implementations and examples may be possible by combining the features and elements of individual implementations and examples.

### Example Communication System

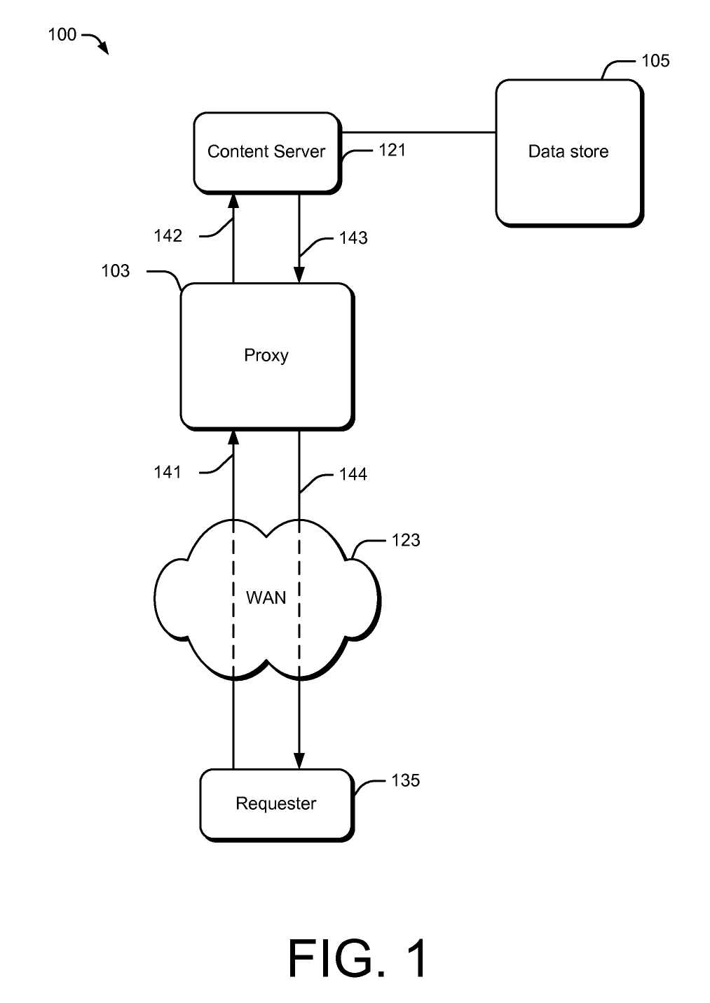

FIG. 1 is a graphical representation of a communication system 100 that may implement, at least in part, the disclosed care-of-address handover techniques and processes. In the most basic configuration, communication system 100 includes a proxy 103 (e.g., NAT/proxy) and a content server 121. The proxy 103 is, for example, a computing device configured to route and handle requests for content managed by a content server 121, which is also a computing device. The content typically contains items that are provided by the content server 121 in real-time. Such items may include, data communications, real-time media streaming, VoIP data, or the like. Such items may be stored in a data store 105. The data store 105 may be any type of computer-readable media, such as volatile and non-volatile media, and removable and non-removable media. The computer-readable media may be tangible.

The proxy 103 may be configured to receive a request for content from a requester 135, which may be a mobile node, a user's computer, another network computer, computing device, or some other device capable of communicating with the proxy 103. The proxy 103 may be alternatively configured to only deliver information to the requester 135.

The server 121 and the requester 135 may be in a peer-to-peer, point-to-point, or end-to-end communication configuration, or the like. In addition, one or both of the server 121 and the requester 135 may be stationary or moving (e.g., nomadic). Therefore, the server 121 and the requester 135 may be regularly changing network interface types. For example, from a first wireless network interface to a second wireless network interface, or from a wireless network interface to a wireline network interface, or from a wireline network interface to a wireless network interface, and so forth.

The proxy 103 is configured to communicate with the requester 135 through a computer network, such as a Wide Area Network (WAN) 123. The WAN 123 may be wireless and/or wireline based network. Specifically, when processing or routing data from the content server 121, proxy 103 is configured to forward the data to the requester 135. Proxy 103 may be implemented as a computing device, such as a server. The proxy 103 may also be implemented as a network appliance, such as a network filter configured to handle outgoing and incoming content. The proxy 103 may be integrated with the content server 121, or a standalone module. The WAN 123 may be any type of wide area network, such as the Internet, wireless network, or the like. In alternate embodiments, any type of network or other communication link can be used to communicate information between the proxy 103 and the content server 121 and between the proxy 103 and the requester 135.

The proxy 103 is capable of routing information for delivery from the content server 121 to a care-of-address associated with the requester 135. In one example, the proxy 103 receives content from the content server 121 that is indicated as being for delivery to a first care-of-address. The proxy 103 having stored in a storage thereof a second care-of-address that is an update of the first care-of-address, forwards the content to the second care-of-address. Therefore, the content server 121 is insulated from having to use the second care-of-address.

The content server 121 is a computing device configured to receive a request for content from the requester 135 and to generate the content or provide content in accordance with the request.

Events 141-144 represent an example signal flow of communication system 100. At the event 141, the proxy 103 receives a message from the requester 135. In one implementation, the message is an Internet Control Message Protocol (ICMP) message. In another implementation, the message is one or more packets that carry information. The message associated with the event 141 includes at least a first care-of-address and a second care-of-address. The message may also include a destination address of the content server 121, which may be an IP address, a TCP port of the content server 121 and a TCP port of the requester 135. The message serves to inform the proxy 103 that the requester 135 is moving from the first care-of-address to the second care-of-address. Moreover, the message serves, if such content is part of the message, to inform the proxy 103 that content for delivery from the content server 121, having the associated destination address (e.g., IP address) and TCP port, is to be routed to the second care-of-address and TCP port of the requester 135 rather than the first care-of-address. The proxy 103 stores the content of the message for future reference. At event 142, if additional data or information is included with the message, it is routed to the content server 121. However, in one implementation, the change of care-of-address and other related information from the message is not routed to the content server 121. That is, in one implementation, only data is routed to the content server 121.

At event 143, the content server 121 communicates data for delivery to the requester 135. Packets associated with the data identify the recipient's care-of-address as being the first care-of-address of the requester 135. However, at event 144, the proxy 103 having stored the content of the message from event 141, which at least includes the second care-of-address of the requester 135, routes the data to the second care-of-address of the requester 135. The packets associated with the data from event 143 may also identify a TCP port associated with the first care-of-address of the requester 135. The proxy 103 may also store a TCP port of the second care-of-address that is different than the TCP port identified in the packets associated with the data. In such a circumstance, the proxy 103, at event 144, routes the data to the second care-of-address and its associated TCP port of the requester 135.

The foregoing has described that the proxy 103 is to implement a change of care-of-address at the requester 135. In an alternative implementation, the requester 135 sends the same message (e.g., a message with at least a first care-of-address and a second care-of-address) to inform the content server 121 of a change of care-of-address at the requester 135. Rather than implementing a proxy to handle subsequent data delivery to the requester 135, the content server 121 may update the TCP/IP stack by replacing the first care-of-address with the second care-of-address.

### Representative Message Packet

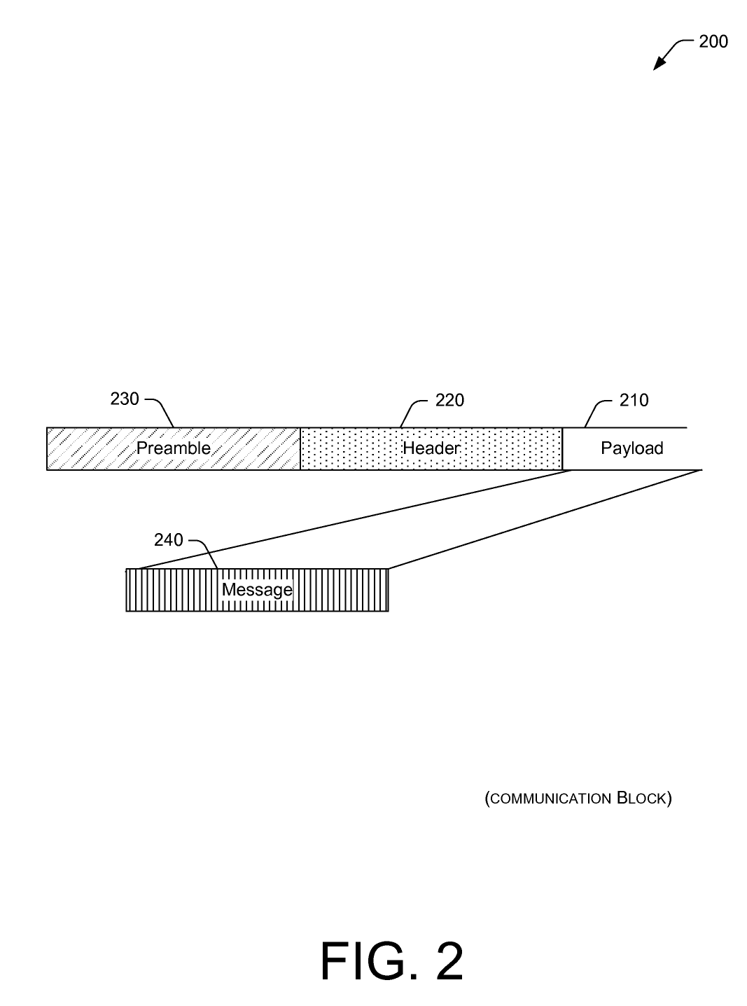

FIG. 2 is a schematic of an example communication block 200, according to an implementation. In one implementation, the communication block 200 is a message packet that may be used to convey care-of-address information. The communication block 200 may include a payload 210 with a header 220. A preamble 230 is prepended to or associated with the communication block 200. The preamble 230 is the first part of the communication block 200, and intended so that the receiver (e.g., proxy 103 and/or server 121) can detect the presence of the frame on a medium, adjust the gain of front end, and synchronize the clock. The header 220 carries necessary information for the receiver to address, demodulate, and decode the payload 210. In one implementation, the payload portion of the communication block 200 carries a message 240 that includes a current care-of-address (e.g., a first care-of-address) and a new care-of-address (e.g., a second care-of-address). That message 240 may be an ICMP message. Furthermore, the message 240 may also include an address of a destination device (e.g., server 121), a port of a source device (e.g., the requester 135), and a port of the destination device. The communication block may be generated by a computing device, such as the requester 135. Moreover, although the message 240 is illustrated as being part of the payload 210, the message 240 located in any portion of the communication block 200, such as the preamble 230 or the header 220.

### Representative Processes

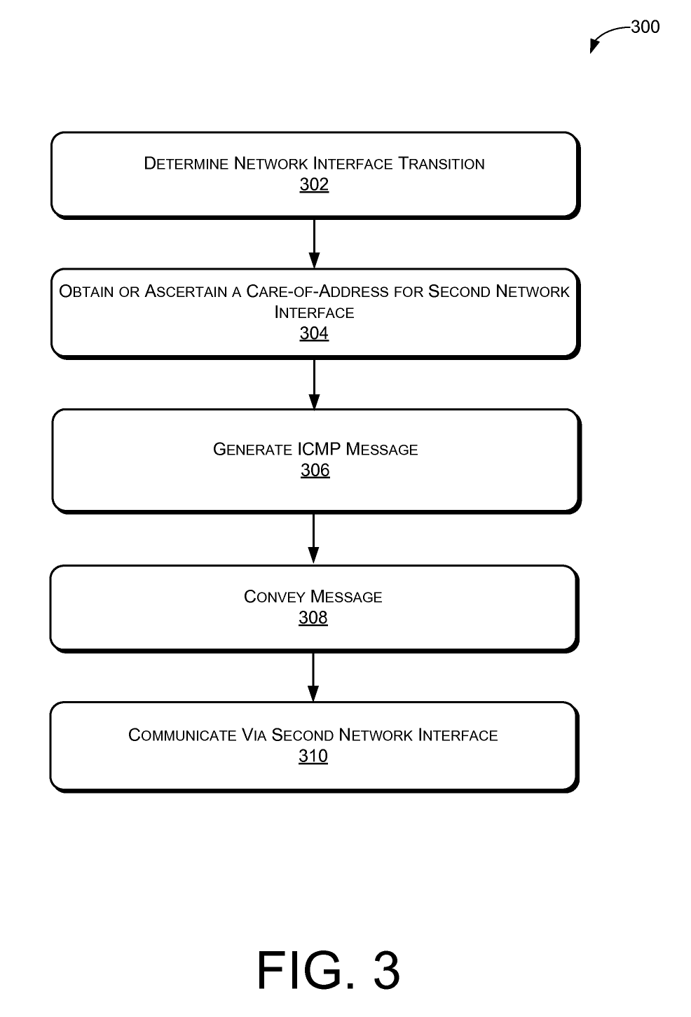

FIG. 3 illustrates a representative process 300 to initiate a change in a care-of-address associated with computing device, such as the requester 135.

At Act 302, a computing device determines that it will transition from a first network interface to a second network interface. The computing device may be the requester 135.

At Act 304, the computer device, such as the requester 135, ascertains or obtains a care-of-address for the second network interface. It is assumed here that the requester 135 is already aware of its current care-of-address (e.g., a first care-of-address).

At Act 306, the computing device, such as the requester 135, generates a message, such as an ICMP message, that includes at least the care-of-address of the first network interface and a care-of-address of the second network interface. The message may also include a destination address of a destination computing device, such as the content server 121 or the data store 105, which may be an IP address, a TCP port of the destination computing device, and a TCP port of generating computing device.

At Act 308, the message is conveyed to the destination computing device. In one implementation, the message is conveyed to a proxy associated with the destination computing device, where the proxy is positioned between the computing device, such as the requester 135, and the destination device, such as the content server 121.

At Act 310, the computing device commences conveying and receiving data (e.g., messages) via the second network interface.

### Representative Computing Device

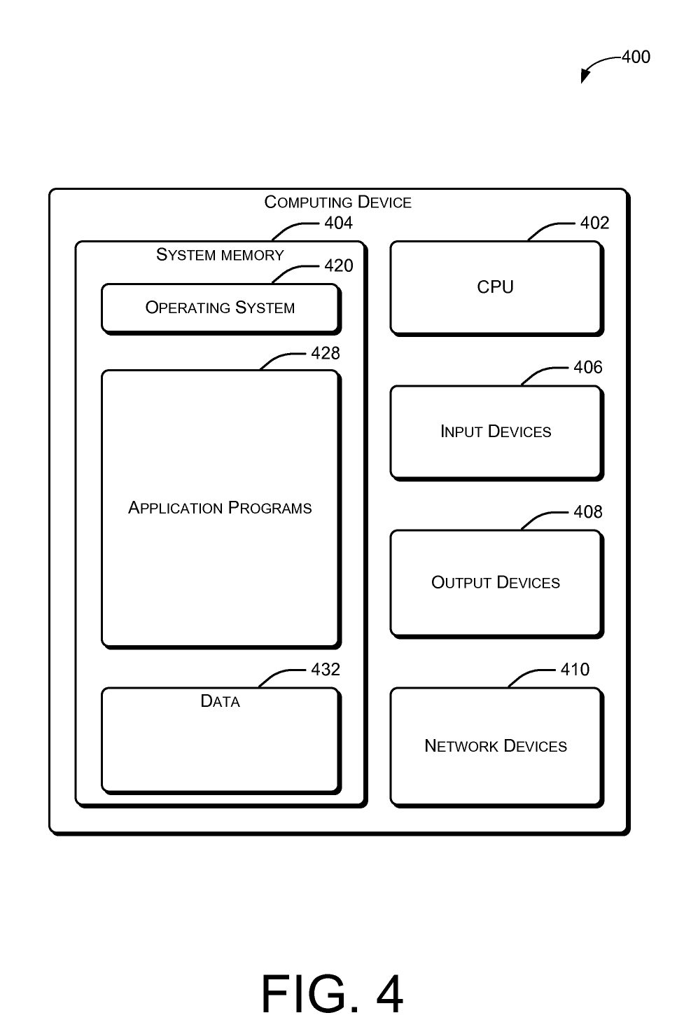

FIG. 4 illustrates an example computing device 400 within which the described systems and methods can be either fully or partially implemented. Computing device 400 is only one example of a computing system and is not intended to suggest any limitation as to the scope of the use or functionality of the invention.

Computing device 400 can be implemented with numerous other general purpose or special purpose computing system environments or configurations. Examples of well known computing systems, environments, and/or configurations that may be suitable for use include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, gaming consoles, distributed computing environments that include any of the above systems or devices, and the like.

The components of computing device 400 can include, but are not limited to, processor 402 (e.g., any of microprocessors, controllers, and the like), system memory 404, input devices 406, output devices 408, and network devices 410. The network devices 410 may include a first and second network device interface. For example the first network device may be a wireless device interface that may have an associated care-of-address and the second network device may be a wireline device interface with an associated care-of-address.

Computing device 400 typically includes a variety of computer-readable media. Such media can be any available media that is accessible by computing device 400 and includes both volatile and non-volatile media, removable and non-removable media. System memory 404 includes computer-readable media in the form of volatile memory, such as random access memory (RAM), and/or non-volatile memory, such as read only memory (ROM). A basic input/output system (BIOS), containing the basic routines that help to transfer information between elements within computing device 400, such as during start-up, is stored in system memory 404. System memory 404 typically contains data and/or program modules that are immediately accessible to and/or presently operated on by processor 402.

System memory 404 can also include other removable/non removable, volatile/non-volatile computer storage media. By way of example, a hard disk drive may be included for reading from and writing to a non-removable, non-volatile magnetic media; a magnetic disk drive may be included for reading from and writing to a removable, non-volatile magnetic disk (e.g., a “floppy disk”); and an optical disk drive may be included for reading from and/or writing to a removable, non-volatile optical disk such as a CD ROM, DVD, or any other type of optical media.

The disk drives and their associated tangible computer-readable media provide non volatile storage of computer-readable instructions, data structures, program modules, and other data for computing device 400. It is to be appreciated that other types of computer readable media which can store data that is accessible by computing device 400, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement exemplary computing device 400. Any number of program modules can be stored in system memory 404, including by way of example, an operating system 420, application programs 428, and data 432.

Computing device 400 can include a variety of computer readable media identified as communication media. Communication media typically embodies computer readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

A user can enter commands and information into computing device 400 via input devices 406 such as a keyboard and a pointing device (e.g., a “mouse”). Other input devices 406 may include a microphone, joystick, game pad, controller, satellite dish, serial port, scanner, touch screen, touch pads, key pads, and/or the like. Output devices 408 may include a CRT monitor, LCD screen, speakers, printers, and the like.

Computing device 400 may include network devices 410 for connecting to computer networks, such as local area network (LAN), wide area network (WAN), and the like.

In alternate implementations, one or more of the above techniques may be employed concurrently, or another technique may be used to accomplish the same or similar results. The implementations herein are described in terms of exemplary embodiments. However, it should be appreciated that individual aspects of the implantations may be separately claimed and one or more of the features of the various embodiments may be combined.

The arrangements, procedures and protocols of the described implementations may be implemented on a special purpose computer, a programmed microprocessor or microcontroller and peripheral integrated circuit element(s), an ASIC or other integrated circuit, a digital signal processor, a flashable device, a hard-wired electronic or logic circuit such as discrete element circuit, a programmable logic device such as PLD, PLA, FPGA, PAL, a transmitter/receiver, any comparable device, or the like. In general, any apparatus capable of implementing a state machine that is in turn capable of implementing the methodology described and illustrated herein may be used to implement the various communication methods, protocols and techniques according to the implementations.

Furthermore, the disclosed procedures may be readily implemented in software using object or object-oriented software development environments that provide portable source code that can be used on a variety of computer or workstation platforms. Alternatively, the disclosed arrangements may be implemented partially or fully in hardware using standard logic circuits or VLSI design. The communication arrangements, procedures and protocols described and illustrated herein may be readily implemented in hardware and/or software using any known or later developed systems or structures, devices and/or software by those of ordinary skill in the applicable art from the functional description provided herein and with a general basic knowledge of the computer and telecommunications arts.

### CONCLUSION

Although the implementations of the disclosure have been described in language specific to structural features and/or methodological acts, it is to be understood that the implementations are not necessarily limited to the specific features or acts described. Rather, the specific features and acts are disclosed as representative forms of implementing the invention.

What is claimed is:

1. A node, comprising:
a controller; and
a storage memory coupled to the controller and including instructions to generate at least one communication for communication on a communication network medium when executed by the controller, the at least one communication to include:
a header, and
a payload, the payload including a message that includes a first care-of-address and a second care-of-address.

2. The node of claim 1, wherein the message is an Internet Control Message Protocol (ICMP) message.

3. The node of claim 1, wherein the message further includes a port reference of the node and an address and port reference of a destination node.

4. The node of claim 1, wherein the first care-of-address is a current care-of-address in use by the node and the second care-of-address is a subsequent care-of-address for use by the node.

5. The node of claim 1, further comprising first and second network interfaces, the first care-of-address associated with the first network interface and the second care-of-address associated with the second network interface.

6. A method, comprising:
generating, at a communication node, a communication including a header and a payload, the payload including a message that includes a first care-of-address and a second care-of-address; and
transmitting the communication.

7. The method of claim 6, wherein the message is an Internet Control Message Protocol (ICMP) message.

8. The method of claim 6, wherein the message further includes a port reference of the communication node and an address and port reference of a destination node.

9. The method of claim 6, wherein the first care-of-address is a current care-of address in use by the node and the second care-of-address is a subsequent care-of address for use by the node.

10. The method of claim 6, further comprising first and second network interfaces associated with the node, the first care-of-address associated with the first network interface and the second care-of-address associated with the second network interface

11. An arrangement, comprising:
a server; and
a proxy coupled to the server, the proxy configured to:
receive a message that includes a first care-of-address and a second care-of-address;
receive a communication for delivery to the first care-of-address; and
transmit the communication for delivery to the first care-of-address to the second care-of-address.

12. The arrangement of claim 11, wherein the message further includes an address of the server, a port of the server and a port of a device that conveyed the message.

13. The arrangement of claim 11, wherein the message is Internet Control Message Protocol (ICMP) message.

14. The arrangement of claim 11, wherein the first care-of-address is a current care-of-address in use by a node having provided the message and the second care-of-address is a subsequent care-of-address for use by the node.

15. A tangible computer-readable media including instructions executable by one or more processors to perform operations, comprising:
generating a communication including a payload, the payload including a message that includes a first care-of-address and a second care-of-address; and
transmitting the communication.

16. The tangible computer-readable media of claim 15, wherein the communication is an Internet Control Message Protocol (ICMP) message.

17. The tangible computer-readable media of claim 15, wherein the communication further includes a port reference of the communication node and an address and port reference of a destination node.

18. The tangible computer-readable media of claim 15, wherein the first care-of address is a current care-of-address in use by a node and the second care-of-address is a subsequent care-of-address for use by the node.

19. The tangible computer-readable media of claim 18, further comprising first and second network interfaces associated with the node, the first care-of-address associated with a first network interface and the second care-of-address associated with a second network interface.

20. The tangible computer-readable media of claim 15, wherein the communication further includes a header.
